(19) United States
(12) Patent Application Publication
(10) Pub. No.: US 2026/0105930 A1
(43) Pub. Date: Apr. 16, 2026

(54) MAGNETIC TAPE AND TAPE CARTRIDGE

(71) Applicant: Sony Group Corporation, Tokyo (JP)

(72) Inventors: Eiji NAKASHIO, Tokyo (JP); Hiroshi KUMAGAI, Tokyo (JP); Masaki SUGAWARA, Tokyo (JP); Taeko TAKAHASHI, Tokyo (JP); Takanobu IWAMA, Tokyo (JP)

(21) Appl. No.: 19/112,457

(22) PCT Filed: Aug. 22, 2023
(86) PCT No.: PCT/JP2023/030077

§ 371 Date: Mar. 17, 2025

(30) Foreign Application Priority Data
Oct. 6, 2022 (JP) 2022-161388

(51) Int. Cl. G11B 5/008; G11B 5/73

(52) U.S. Cl. CPC G11B 5/00813; G11B 5/73

(57) ABSTRACT

A magnetic tape according to an embodiment of the present technology is a magnetic tape including a base material and a magnetic layer provided on one of main surfaces of the base material, in which the base material is formed of polyethylene naphthalate (PEN), a total thickness of the magnetic tape is 4.9 μm or more and 5.4 μm or less, and a loop stiffness of the magnetic tape in a width direction thereof is 1.1 mg/μm or more and 1.4 mg/μm or less.

### TECHNICAL FIELD

The present technology relates to a magnetic tape and a tape cartridge which accommodates the magnetic tape therein.

### BACKGROUND ART

There is known a magnetic tape cartridge in which a magnetic tape is wound on a single tape reel, and the tape reel is rotatably accommodated in a cartridge case (see, for example, Patent Literature 1). This type of single-reel-type magnetic tape cartridge is used for data storage of a computer and the like.

In the single-reel-type tape cartridge, a tape drive device is used to record information onto the magnetic tape or reproduce information recorded onto the magnetic tape. When the tape cartridge is attached to the tape drive device, the magnetic tape is drawn out from the tape cartridge to be reeled in by a take-up reel on the tape drive device side. A magnetic head is arranged on a tape path from the tape cartridge to the take-up reel. Then, the magnetic tape is moved relatively with respect to the magnetic head by a winding operation of the magnetic tape by the take-up reel and a rewinding operation of the magnetic tape from the take-up reel so that recording or reproduction of information by the magnetic head is performed.

Furthermore, as the tape drive device, for example, there is known, in addition to a full-height-type drive device applied to a large-scale library, a half-height-type drive device that is configured to have half the height of the full height type (see, for example, Patent Literature 2). The only difference between the full-height-type tape drive device and the half-height-type tape drive device is their height dimensions, and there is no significant difference in information recording/reproducing performance with respect to the tape cartridge. Thus, under the current circumstances, the devices are used distinguishably according to usage environments of users.

### CITATION LIST

### Patent Literature

Patent Literature 1: Japanese Patent Application Laid-open No. 2009-211743
Patent Literature 2: Japanese Patent Application Laid-open No. 2013-530483

### DISCLOSURE OF INVENTION

### Technical Problem

Meanwhile, depending on the configuration of the tape cartridge, anomalies in recording/reproducing operations that are unproblematic during use of the full-height-type tape drive device may be caused during use of the half-height-type tape drive device. This is predicted to be because effects of shape accuracy of mechanism components configuring the tape drive device, processing accuracy or rigidity of the magnetic tape, and furthermore, differences in terms of configurations or physical properties of a tape reel structure and the like on the recording/reproducing operations appear prominently in the half-height-type tape drive device.

Specifically, there is a fear that during use of the half-height-type tape drive device, the relative position of the tape with respect to the magnetic head will vary due to lowering of linearity that is unavoidable in a manufacturing process of the magnetic tape, lowering of shape accuracy of the take-up reel in the tape drive device, and the like, to inhibit normal information recording or reproducing operations by the magnetic head.

In view of the circumstances as described above, the present technology aims at providing a magnetic tape capable of securing stable recording/reproducing characteristics irrespective of the type of the tape drive device, and a tape cartridge including the same.

### Solution to Problem

A magnetic tape according to an embodiment of the present technology is a magnetic tape including: a base material; and a magnetic layer provided on one of main surfaces of the base material, in which
the base material is formed of polyethylene naphthalate (PEN), a total thickness of the magnetic tape is 4.9 μm or more and 5.4 μm or less, and a loop stiffness of the magnetic tape in a width direction thereof is 1.1 mg/μm or more and 1.4 mg/μm or less.

The magnetic tape may further include: a non-magnetic layer provided between the base material and the magnetic layer; and a back layer provided on another one of the main surfaces of the base material.

A thickness of the base material may be 4.2 μm or less, 4.1 μm or less, or 4.0 μm or less.

The magnetic layer may contain magnetic particles of hexagonal ferrite, ε iron oxide, or cobalt-containing ferrite.

A squareness ratio of the magnetic layer in a longitudinal direction of the magnetic tape may be 35% or less.

A coercive force of the magnetic layer may be 2000 Oe or less.

A shrinkage rate of the magnetic tape in a longitudinal direction thereof when stored at 70° C. for 48 hours may be 0.1% or less.

A tape cartridge according to an embodiment of the present technology includes a tape reel and a magnetic tape.

The tape reel includes a first flange, a second flange, and a cylindrical reel hub including a first end portion formed integrally with the first flange and a second end portion to which the second flange is bonded.

The magnetic tape includes a base material and a magnetic layer provided on one of main surfaces of the base material and is wound on an outer circumferential surface of the reel hub.

The base material is formed of polyethylene naphthalate (PEN), a total thickness of the magnetic tape is 4.9 μm or more and 5.4 μm or less, and a loop stiffness of the magnetic tape in a width direction thereof is 1.1 mg/μm or more and 1.4 mg/μm or less.

The magnetic tape may be curved in a shape that becomes convex toward a side of the second flange, and a deviation of the magnetic tape from a chord having a length of 1 m may be 3.8 mm or less.

An inner surface of the first flange and an inner surface of the second flange may be each formed as a tapered surface that widens toward an outer circumferential side of the tape reel.

A minimum value of a distance between the first flange and the second flange along an axial direction of the hub may be 12.9 mm+0.14 mm.

A maximum value of a distance between the first flange and the second flange along an axial direction of the hub may be 13.125 mm+0.195 mm.

### BRIEF DESCRIPTION OF DRAWINGS

FIG. 1 Overall perspective views each showing a tape cartridge according to an embodiment of the present technology, in which (A) is a perspective view when seen from an upper surface (upper shell) side, and (B) is a perspective view when seen from a lower surface (lower shell) side.

FIG. 2 An exploded perspective view of the tape cartridge.

FIG. 3 An exploded cross-sectional side view of the tape cartridge.

FIG. 4 A schematic diagram in which a magnetic tape according to the embodiment of the present technology is seen from the side.

FIG. 5 A plan view showing a schematic configuration of a tape drive device.

FIG. 6 An experimental result showing a relationship between a tape length and a magnitude of a position error signal (PES: Position Error Signal) of a data track when information is recorded onto the magnetic tape using a half-height-type tape drive device.

FIG. 7 A measurement result of a flange surface shape of a take-up reel of the tape drive device.

FIG. 8 A schematic diagram for explaining a curvature direction of the magnetic tape.

FIG. 9 Schematic diagrams for explaining a state of the magnetic tape reeled in by the take-up reel, in which (A) shows a state where the curvature direction of the magnetic tape is minus, and (B) shows a state where the curvature direction of the magnetic tape is plus.

FIG. 10 A schematic side view showing a configuration of a tape reel in the tape cartridge.

### MODES FOR CARRYING OUT THE INVENTION

Hereinafter, an embodiment of the present technology will be described with reference to the drawings.

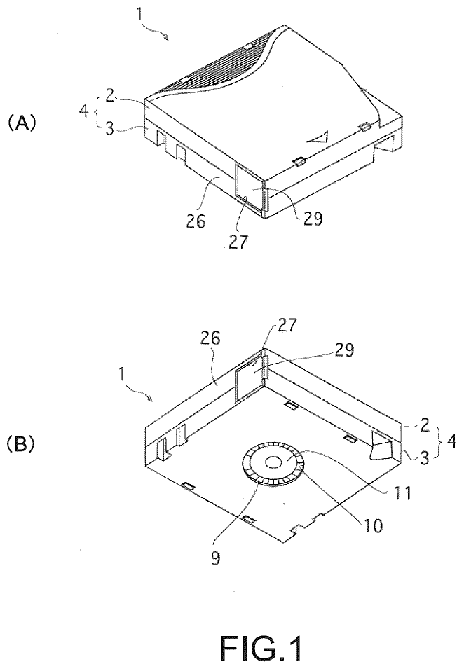

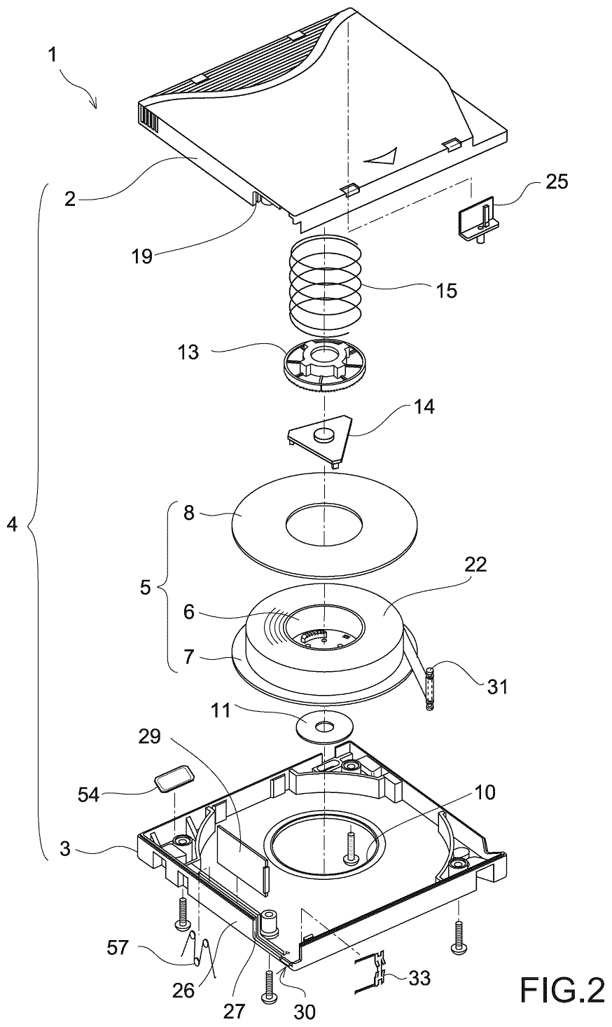

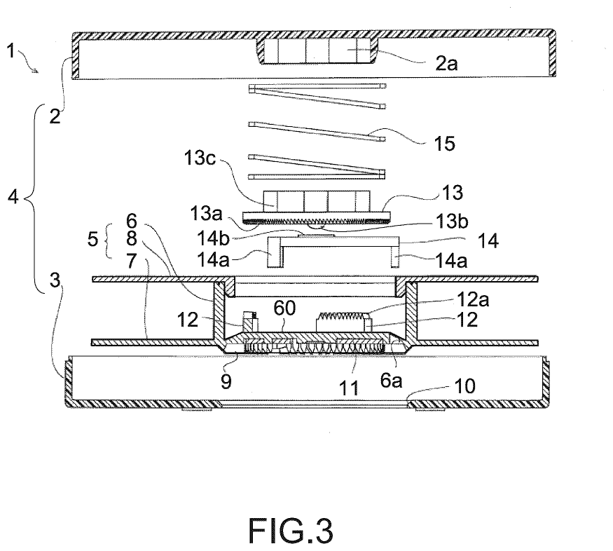

FIG. 1 are overall perspective views each showing a tape cartridge 1 according to the embodiment of the present technology, in which (A) is a perspective view when seen from an upper surface (upper shell 2) side, and (B) is a perspective view when seen from a lower surface (lower shell 3) side. FIG. 2 is an exploded perspective view of the tape cartridge 1, and FIG. 3 is an exploded cross-sectional side view thereof.

### [Overall Configuration of Tape Cartridge]

The tape cartridge 1 according to the present embodiment has a configuration in which a single tape reel 5 on which a magnetic tape 22 is wound is rotatably accommodated inside a cartridge case 4 formed by combining the upper shell 2 and the lower shell 3 by a plurality of screw members. Hereinafter, the tape cartridge 1 according to the present embodiment will be described while taking a magnetic tape cartridge conforming to an LTO (Linear Tape Open) standard as an example.

The tape reel 5 includes a cylindrical reel hub 6 having a bottom, a lower flange 7 formed integrally with a lower end portion of the reel hub 6, and an upper flange 8 bonded to an upper end portion of the reel hub 6, that are each formed by an injection molded body formed of a synthetic resin material.

A chucking gear 9 that engages with a reel rotary drive shaft of a tape drive device is formed annularly at a center of a lower surface of the tape reel 5, and the chucking gear 9 is exposed to the outside via an opening portion 10 provided at a center of the lower shell 3 as shown in FIG. 1(B). On an inner circumferential side of this chucking gear 9, an annular metal plate 11 which magnetically sticks to the reel rotary drive shaft is fixed to an outer surface of a bottom portion of the reel hub 6 by insert molding.

Inside the reel hub 6, a reel lock mechanism for suppressing rotations of the tape reel 5 when the tape cartridge 1 is not used is provided. As shown in FIG. 3, the reel lock mechanism includes: a plurality of gear forming walls 12 erected on an upper surface of the bottom portion 60 of the reel hub 6; a reel lock member 13 including engagement teeth 13a that intermesh with gear portions 12a formed on upper surfaces of the gear forming walls 12; a reel lock release member 14 for releasing the engagement between the gear forming walls 12 and the reel lock member 13; and a reel spring 15 provided between an inner surface of the upper shell 2 and an upper surface of the reel lock member 13. The reel spring 15 is a coil spring and biases the tape reel 5 toward the lower shell 3 side via the reel lock member 13.

The gear forming walls 12 each have a circular arc shape and are formed concyclically at three positions at regular intervals about a shaft center of the reel hub 6 on the upper surface of the bottom portion 60 of the reel hub 6. The engagement teeth 13a of the reel lock member 13 that oppose the gear portions 12a of the gear forming walls 12 are formed annularly on a lower surface of the reel lock member 13 and are constantly biased in a direction in which they engage with the gear portions 12a by the reel spring 15. A fitting convex portion 13c is formed on the upper surface of the reel lock member 13, and a fitting concave portion 2a that fits with this fitting convex portion 13c is formed at substantially a center portion of the inner surface of the upper shell 2.

The reel lock release member 14 has substantially a triangular shape and is arranged between the bottom portion 60 of the reel hub 6 and the reel lock member 13. On a lower surface of the reel lock release member 14, a total of three legs 14a are formed to protrude downwardly from vicinity of respective vertices of the substantially triangular shape, and these legs are positioned among gears of the chucking gear 9 via insertion holes 6a formed at the bottom portion 60 of the reel hub 6 when the cartridge is not used.

During use of the cartridge, the legs 14a of the reel lock release member 14 are pressed upwardly by the reel rotary drive shaft of the tape drive device that engages with the chucking gear 9 so as to cause the reel lock member 13 to move to a lock release position against a bias force of the reel spring 15, and are further configured to be rotatable with respect to the reel lock member 13 together with the tape reel 5. At substantially a center portion of an upper surface of the reel lock release member 14, a supporting surface 14b which supports a slide contact portion 13b that has a circular arc cross section and is formed at substantially a center portion of the lower surface of the reel lock member 13 while protruding is provided.

A drawing port 27 for drawing out one end of the magnetic tape 22 to the outside is provided on one side wall 26 of the cartridge case 4. A slide door 29 which opens and closes the drawing port 27 is arranged on an inner side of the side wall 26. The slide door 29 is configured to slide in a direction of opening the drawing port 27 against a bias force of a torsion spring 57 by an engagement with a tape loading mechanism (not shown) of the tape drive device.

A leader pin 31 is fixed at one end portion of the magnetic tape 22. The leader pin 31 is configured to be attachable/detachable to/from pin retention portions 33 provided on the inner side of the drawing port 27. The pin retention portions 33 are respectively attached to an inner surface of the upper shell 2 and an inner surface of the lower shell 3 so as to be capable of elastically retaining an upper end portion and lower end portion of the leader pin 31, respectively.

Also inside the cartridge case 4, a cartridge memory 54 from/to which content related to information recorded on the magnetic tape 22 can be read and written in a non-contact manner is arranged in addition to a safety tab 25 for preventing accidental deletion of information recorded on the magnetic tape 22. The cartridge memory 54 is constituted of a non-contact communication medium in which an antenna coil, an IC chip, and the like are mounted on a substrate.

### [Magnetic Tape]

Next, the magnetic tape 22 will be described.

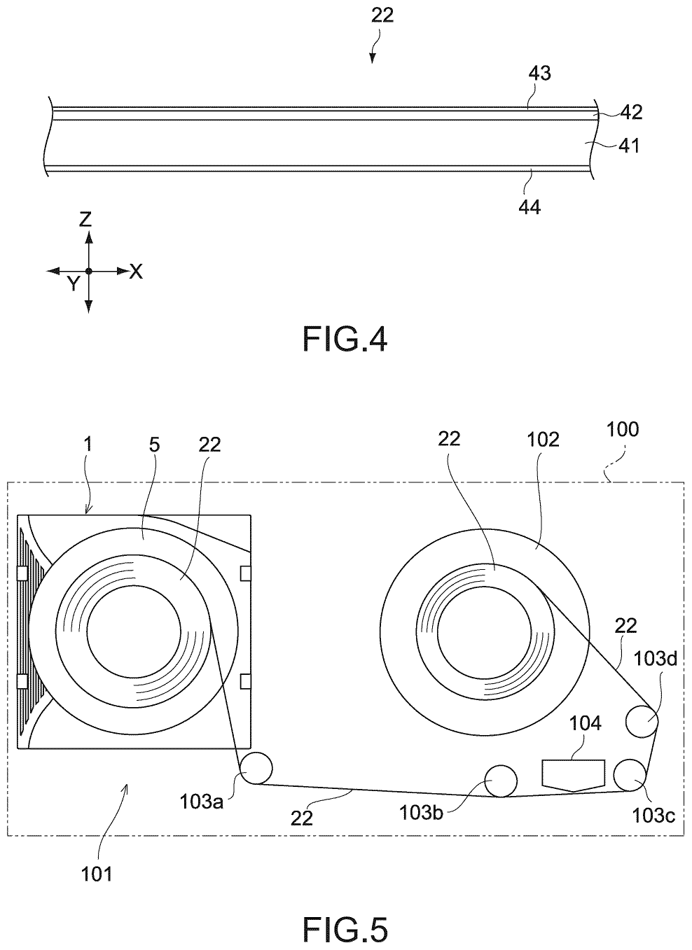

FIG. 4 is a schematic diagram in which the magnetic tape 22 is seen from the side. As shown in FIG. 4, the magnetic tape 22 is formed in a tape-like shape that is elongated in a longitudinal direction (X axis direction), is short in a width direction (Y axis direction), and is thin in a thickness direction (Z axis direction).

The magnetic tape 22 includes a tape-type base material 41 elongated in the longitudinal direction (X axis direction), an underlayer (non-magnetic layer) 42 provided on one of main surfaces of the base material 41, a magnetic layer 43 provided above the underlayer 42, and a back layer 44 provided on the other one of the main surfaces of the base material 41. It is noted that the back layer 44 only needs to be provided as necessary, and the back layer 44 may be omitted. The magnetic tape 22 may be a vertical-recording-type magnetic recording medium, or may be a longitudinal-recording-type magnetic recording medium.

The magnetic tape 22 has an elongated tape-like shape and travels in the longitudinal direction during recording/reproduction. It is noted that a surface of the magnetic layer 43 becomes a surface on which a magnetic head provided in a recording/reproducing device (tape drive device, see FIG. 5) travels. It is favorable for the magnetic tape 22 to be used in a recording/reproducing device that includes a ring-type head as a recording head. It is favorable for the magnetic tape 22 to be used in a recording/reproducing device that is configured to be capable of recording data at a data track width of 1500 nm or less or 1000 nm or less.

### (Base Material)

The base material 41 is a non-magnetic supporting body which supports the underlayer 42 and the magnetic layer 43. The base material 41 has an elongated film shape. An upper limit value of an average thickness of the base material 41 is favorably 4.4 μm or less, more favorably 4.2 μm or less, further more favorably 4.0 μm or less. When the upper limit value of the average thickness of the base material 41 is 4.2 μm or less, a recording capacity that can be recorded in one data cartridge can be made larger than that of a general magnetic tape. A lower limit value of the average thickness of the base material 41 is favorably 3 μm or more, more favorably 3.2 μm or more. When the lower limit value of the average thickness of the base material 41 is 3 μm or more, lowering of strength of the base material 41 can be suppressed.

The average thickness of the base material 41 is obtained as follows. First, the magnetic tape 22 having a width of ½ inch is prepared and cut out at a length of 250 mm, to produce a sample. Subsequently, layers of the sample other than the base material 41 (that is, the underlayer 42, the magnetic layer 43, and the back layer 44) are removed by using a solvent such as MEK (methyl ethyl ketone) or dilute hydrochloric acid. Next, using a laser hologauge (LGH-110C) manufactured by Mitutoyo Corporation as a measurement device, a thickness of the sample (base material 41) is measured at five positions or more, and those measurement values are simply averaged (arithmetic average), to thus calculate the average thickness of the base material 41. It is noted that the measurement positions are randomly selected from the sample.

The base material 41 contains polyester. By the base material 41 containing polyester, a Young's modulus in a longitudinal direction of the base material 41 can be reduced. Accordingly, a width of the magnetic tape 22 can be maintained constant or almost constant by adjusting a tension applied in the longitudinal direction of the magnetic tape 22 during traveling by the recording/reproducing device.

Polyester includes, for example, at least one type selected from polyethylene terephthalate (PET), polyethylene naphthalate (PEN), polybutylene terephthalate (PBT), polybutylene naphthalate (PBN), polycyclohexylene dimethylene terephthalate (PCT), polyethylene-p-oxybenzoate (PEB), and polyethylene bisphenoxy carboxylate. When the base material 41 contains two or more types of polyester, those two or more types of polyester may be mixed, copolymerized, or laminated. At least one of a terminal or side chain of polyester may be denaturalized.

The fact that polyester is contained in the base material 41 is confirmed as follows, for example. First, similar to the measurement method for the average thickness of the base material 41, layers of the sample other than the base material 41 are removed. Next, an IR spectrum of the sample (base material 41) is acquired by infrared absorption spectrometry (Infrared Absorption Spectrometry: IR). Based on this IR spectrum, the fact that polyester is contained in the base material 41 can be confirmed.

The base material 41 may further contain, for example, in addition to polyester, at least one type selected from polyamide, polyetheretherketone, polyimide, and polyamide imide, or may further contain at least one type selected from polyamide, polyimide, polyamide imide, polyolefins, cellulose derivatives, a vinyl-based resin, and other polymer resins. Polyamide may be aromatic polyamide (aramid). Polyimide may be aromatic polyimide. Polyamide imide may be aromatic polyamide imide.

When the base material 41 contains a polymer resin other than polyester, it is favorable for the base material 41 to contain polyester as a main component. Herein, the main component refers to a component having largest content (mass ratio) among the polymer resins contained in the base material 41. When the base material 41 contains a polymer resin other than polyester, polyester and the polymer resin other than polyester may be mixed or copolymerized.

The base material 41 may be biaxially stretched in the longitudinal direction and the width direction. It is favorable for the polymer resin contained in the base material 41 to be oriented in an oblique direction with respect to the width direction of the base material 41.

### (Magnetic Layer)

The magnetic layer 43 is a recording layer for recording signals by magnetization patterns. The magnetic layer 43 may be a vertical-recording-type recording layer, or may be a longitudinal-recording-type recording layer. The magnetic layer 43 contains, for example, magnetic particles, a binding agent, and a lubricant. The magnetic layer 43 may further contain, as necessary, at least one type of additive selected from an antistatic agent, an abrasive, a curing agent, a rust inhibitor, non-magnetic reinforcement particles, and the like. The magnetic layer 43 is not limited to the case of being formed by a coated film of a magnetic material and may alternatively be formed by a sputtering film or a vapor-deposited film of the magnetic material.

An arithmetic average roughness Ra of the surface of the magnetic layer 43 is 2.0 nm or less, favorably 1.8 nm or less, more favorably 1.6 nm or less. When the arithmetic average roughness Ra is 2.0 nm or less, lowering of an output due to spacing loss can be suppressed, and thus excellent electromagnetic conversion characteristics can be obtained. A lower limit value of the arithmetic average roughness Ra of the surface of the magnetic layer 43 is favorably 1.0 nm or more, more favorably 1.2 nm or more. When the lower limit value of the arithmetic average roughness Ra of the surface of the magnetic layer 43 is 1.0 nm or more, lowering of traveling performance due to an increase of friction can be suppressed.

The arithmetic average roughness Ra is obtained as follows.

First, the surface of the magnetic layer 43 is observed using an AFM (Atomic Force Microscope) to obtain a 40 μm×40 μm AFM image. The AFM used is Nano Scope IIIa D3100 manufactured by Digital Instruments, a cantilever is formed of a silicon single crystal (Note 1), and a measurement is performed at a tuning of 200 to 400 Hz as a tapping frequency.

Next, the AFM image is divided into 512×512 (=262,144) measurement points, a height Z(i) (i: measurement point number, i=1 to 262, 144) is measured at each measurement point, and the measured heights Z(i) at the respective measurement points are simply averaged (arithmetic average), to obtain an average height (average surface) Zave(=(Z(1)+Z(2)+ . . . +Z(262,144))/262,144).

Subsequently, a deviation Z″(i) (=Z(i)−Zave) from an average center line at each measurement point is obtained to calculate the arithmetic average roughness Ra [nm](=(Z″(1)+Z″(2)+ . . . +Z″(262, 144))/262, 144). At this time, a resultant that has been subjected to filtering processing using Flattenorder 2 and planefit order 3 XY as image processing is used as the data.

(Note 1) SPM probe NCH normal type PointProbe L (cantilever length)=125 μm manufactured by Nano World

An upper limit value of an average thickness tₘ of the magnetic layer 43 is 80 nm or less, favorably 70 nm or less, more favorably 50 nm or less. When the upper limit value of the average thickness tₘ of the magnetic layer 43 is 80 nm or less, an effect of demagnetization can be reduced in the case where a ring-type head is used as the recording head, and thus additionally excellent electromagnetic conversion characteristics can be obtained.

A lower limit value of the average thickness tₘ of the magnetic layer 43 is favorably 35 nm or more. When the lower limit value of the average thickness tₘ of the magnetic layer 43 is 35 nm or more, an output can be secured when an MR-type head is used as a reproducing head, and thus additionally excellent electromagnetic conversion characteristics can be obtained.

The average thickness tₘ of the magnetic layer 43 is obtained as follows. First, the magnetic tape 22 as a measurement target is processed and sectioned by an FIB method or the like. When using the FIB method, a carbon layer and a tungsten layer are formed as protective films as preprocessing for observing a TEM image of a cross section to be described later. The carbon layer is formed on a surface of the magnetic tape 22 on the magnetic layer 43 side and a surface thereof on the back layer 44 side by a vapor deposition method, and then the tungsten layer is further formed on the surface on the magnetic layer 43 side by the vapor deposition method or a sputtering method. The sectioning is performed along a length direction (longitudinal direction) of the magnetic tape 22. In other words, by the sectioning, a cross section parallel to both the longitudinal direction and the thickness direction of the magnetic tape 22 is formed.

The cross section of the obtained sectioned sample is observed using a transmission electron microscope (Transmission Electron Microscope: TEM) under the following conditions to obtain a TEM image. It is noted that a magnification and an acceleration voltage may be adjusted as appropriate in accordance with a type of the device.
Device: TEM (H9000NAR manufactured by Hitachi, Ltd.)
Acceleration voltage: 300 kV
Magnification: 100,000 folds

Next, using the obtained TEM image, the thickness of the magnetic layer 43 is measured at at least 10 or more positions in the longitudinal direction of the magnetic tape 22. An average value obtained by simply averaging (arithmetic average) the obtained measurement values is set as the average thickness tₘ [nm] of the magnetic layer 43. It is noted that the measurement positions are randomly selected from the test piece.

### (Magnetic Powder)

Magnetic powder includes a plurality of magnetic particles. For example, the magnetic particles are particles containing hexagonal ferrite (hereinafter, will be referred to as “hexagonal ferrite particles”), particles containing epsilon iron oxide (ε iron oxide) (hereinafter, will be referred to as “ε iron oxide particles”), or particles containing Co-containing spinel ferrite (hereinafter, will be referred to as “cobalt ferrite particles”). It is favorable for the magnetic powder to have a crystalline orientation preferentially in the thickness direction (vertical direction) of the magnetic tape 22.

(Hexagonal ferrite particles)

The hexagonal ferrite particles have, for example, a plate shape such as a hexagonal plate shape. In the present specification, the hexagonal plate shape includes a substantially hexagonal plate shape. Hexagonal ferrite favorably includes at least one type selected from Ba, Sr, Pb, and Ca, or more favorably includes at least one type selected from Ba and Sr. Specifically, for example, hexagonal ferrite may be barium ferrite or strontium ferrite. Barium ferrite may further include at least one type selected from Sr, Pb, and Ca in addition to Ba. Strontium ferrite may further include at least one type selected from Ba, Pb, and Ca in addition to Sr.

More specifically, hexagonal ferrite has an average composition expressed by a general formula MFe₁₂O₁₉. It is noted that M is, for example, at least one type of metal selected from Ba, Sr, Pb, and Ca, favorably at least one type of metal selected from Ba and Sr. M may be a combination of Ba and one or more types of metal selected from the group consisting of Sr, Pb, and Ca. Alternatively, M may be a combination of Sr and one or more types of metal selected from the group consisting of Ba, Pb, and Ca. A part of Fe in the general formula described above may be substituted by other metal elements.

When the magnetic powder contains hexagonal ferrite particle powder, an average particle size of the magnetic powder is favorably 13 nm or more and 22 nm or less, more favorably 13 nm or more and 19 nm or less, further more favorably 13 nm or more and 18 nm or less, particularly favorably 14 nm or more and 17 nm or less, most favorably 14 nm or more and 16 nm or less. When the average particle size of the magnetic powder is 22 nm or less, additionally excellent electromagnetic conversion characteristics (for example, SNR) can be obtained in the magnetic tape 22 having a high recording density. Meanwhile, when the average particle size of the magnetic powder is 13 nm or more, dispersibility of the magnetic powder is improved, and additionally excellent electromagnetic conversion characteristics (for example, SNR) can be obtained.

An average aspect ratio of the magnetic powder is favorably 1.0 or more and 3.0 or less, more favorably 1.3 or more and 2.8 or less, further more favorably 1.6 or more and 2.7 or less. When the average aspect ratio of the magnetic powder is within the range of 1.0 or more and 2.5 or less, an agglomeration of the magnetic powder can be suppressed. In addition, resistance applied to the magnetic powder when vertically orienting the magnetic powder in a process of forming the magnetic layer 43 can be suppressed. Accordingly, a vertical orientation of the magnetic powder can be improved.

When the magnetic powder contains hexagonal ferrite particle powder, the average particle size and average aspect ratio of the magnetic powder are obtained as follows. First, the magnetic tape 22 as the measurement target is processed and sectioned by the FIB method or the like. When using the FIB method, a carbon layer and a tungsten layer are formed as protective films as preprocessing for observing a TEM image of a cross section to be described later. The carbon layer is formed on the surface of the magnetic tape 22 on the magnetic layer 43 side and the surface thereof on the back layer 44 side by the vapor deposition method, and then the tungsten layer is further formed on the surface on the magnetic layer 43 side by the vapor deposition method or the sputtering method. The sectioning is performed along the length direction (longitudinal direction) of the magnetic tape 22. In other words, by the sectioning, a cross section parallel to both the longitudinal direction and the thickness direction of the magnetic tape 22 is formed.

Using a transmission electron microscope (H-9500 manufactured by Hitachi High-Tech Corporation), the cross section of the obtained sectioned sample is subjected to a cross-sectional observation at an acceleration voltage of 200 kV and a total magnification of 500,000 folds in such a manner that the entire magnetic layer 43 is included with respect to the thickness direction of the magnetic layer 43, to thus capture a TEM picture. Next, from the captured TEM picture, 50 particles whose side surfaces are facing a direction of an observation surface and whose particle thicknesses can be visibly confirmed are picked out. A maximum plate thickness DA of each of the picked-out 50 particles for which the thicknesses can be visibly confirmed is measured. The maximum plate thicknesses DA obtained in this manner are simply averaged (arithmetic average) to obtain an average maximum plate thickness DAₐᵥₑ. Subsequently, a plate diameter DB of the magnetic powder is measured. For measuring the plate diameter DB of each of the particles, 50 particles whose particle plate diameters can be visibly confirmed are picked out from the captured TEM picture. The plate diameter DB of each of the picked-out 50 particles is measured. The plate diameters DB obtained in this manner are simply averaged (arithmetic average) to obtain an average plate diameter DBₐᵥₑ. The average plate diameter DBₐᵥₑ is the average particle size. Then, the average aspect ratio (DBₐᵥₑ/DAₐᵥₑ) of the particles is obtained from the average maximum plate thickness DAₐᵥₑ and the average plate diameter DBₐᵥₑ.

When the magnetic powder contains hexagonal ferrite particle powder, an average particle volume of the magnetic powder is favorably 500 nm³ or more and 2500 nm³ or less, more favorably 500 nm³ or more and 1600 nm³ or less, further more favorably 500 nm³ or more and 1500 nm³ or less, particularly favorably 600 nm³ or more and 1200 nm³ or less, most favorably 600 nm³ or more and 1000 nm³ or less. When the average particle volume of the magnetic powder is 2500 nm³ or less, effects similar to those of a case where the average particle size of the magnetic powder is 22 nm or less can be obtained. Meanwhile, when the average particle volume of the magnetic powder is 500 nm³ or more, effects similar to those of a case where the average particle size of the magnetic powder is 13 nm or more can be obtained.

The average particle volume of the magnetic powder is obtained as follows. First, as described above in relation to the method of calculating the average particle size of the magnetic powder, the average long axis length DAₐᵥₑ and the average plate diameter DBₐᵥₑ are obtained. Next, an average volume V of the magnetic powder is obtained by the following equation.

$$V = \frac{3 \sqrt{3}}{8} \times {DA}_{ave} \times {DB}_{ave} \times {DB}_{ave} \qquad [ Equation 1 ]$$

(ε iron oxide particles)

The ε iron oxide particles are hard magnetic particles with which a high coercive force can be obtained even with fine particles. The ε iron oxide particles have a spherical shape or a cubic shape. In the present specification, the spherical shape includes a substantially spherical shape. Furthermore, the cubic shape includes a substantially cubic shape. Since the ε iron oxide particles have the shape as described above, when the ε iron oxide particles are used as the magnetic particles, it is possible to reduce a contact area of the particles in the thickness direction of the magnetic tape 22 and suppress the agglomeration of the particles as compared to a case where barium ferrite particles having a hexagonal plate shape are used as the magnetic particles. Accordingly, it is possible to enhance dispersibility of the magnetic powder and obtain additionally excellent electromagnetic conversion characteristics (for example, SNR).

The ε iron oxide particles may have a composite particle structure. More specifically, the ε iron oxide particle includes an ε iron oxide portion and a portion having a soft magnetic property or a portion having a magnetic property in which a saturation magnetization amount σs is larger and a coercive force Hc is smaller than those of ε iron oxide (hereinafter, will be referred to as “portion having a soft magnetic property or the like”).

The ε iron oxide portion contains ε iron oxide. ε iron oxide contained in the ε iron oxide portion is favorably one having an ε-Fe₂O₃ crystal as a main phase, more favorably one constituted of single-phase ε-Fe₂O₃.

The portion having a soft magnetic property or the like is partially in contact with at least the ε iron oxide portion. Specifically, the portion having a soft magnetic property or the like may partially cover the ε iron oxide portion, or may cover an entire circumference of the ε iron oxide portion.

The portion having a soft magnetic property (the portion having a magnetic property in which the saturation magnetization amount σs is larger and the coercive force Hc is smaller than those of ε iron oxide) contains, for example, a soft magnetic material such as α-Fe, a Ni—Fe alloy, or a Fe—Si—Al alloy. α-Fe may be obtained by reducing ε iron oxide contained in the ε iron oxide portion.

Furthermore, the portion having a soft magnetic property may contain, for example, Fe₃O₄, γ-Fe₂O₃, spinel ferrite, or the like.

By the ε iron oxide particle including the portion having a soft magnetic property or the like as described above, the coercive force Hc of the ε iron oxide particle (composite particle) as a whole can be adjusted to a coercive force Hc suited for recording while maintaining the coercive force Hc of the ε iron oxide portion alone at a large value for securing thermal stability.

The ε iron oxide particle may contain an additive in place of the composite particle structure, or may contain an additive together with the composite particle structure. In this case, a part of Fe in the ε iron oxide particle is substituted by the additive. Also by the ε iron oxide particle containing the additive, the coercive force Hc of the ε iron oxide particle as a whole can be adjusted to a coercive force Hc suited for recording, and thus easiness of recording can be improved. The additive is a metal element other than iron, favorably a trivalent metal element, more favorably at least one type selected from the group consisting of Al, Ga, and In, further more favorably at least one type selected from the group consisting of Al and Ga.

Specifically, ε iron oxide containing the additive is an ε-Fe₂₋ₓMₓO₃ crystal (provided that: M is a metal element other than iron, favorably a trivalent metal element, more favorably at least one type selected from the group consisting of Al, Ga, and In, further more favorably at least one type selected from the group consisting of Al and Ga; and x is, for example, 0<x<1).

When the magnetic particles are the ε iron oxide particles, the average particle size (average maximum particle size) of the magnetic powder is, for example, 22 nm or less. The average particle size (average maximum particle size) of the magnetic powder is favorably 20 nm or less, more favorably 8 nm or more and 20 nm or less, further more favorably 10 nm or more and 18 nm or less, particularly favorably 10 nm or more and 16 nm or less, most favorably 10 nm or more and 14 nm or less. In the magnetic tape 22, an area of a size that is ½ the recording wavelength becomes the actual magnetization area. Therefore, by setting the average particle size of the magnetic powder to be less than half the shortest recording wavelength, additionally excellent electromagnetic conversion characteristics (for example, SNR) can be obtained. Accordingly, when the average particle size of the magnetic powder is 22 nm or less, additionally excellent electromagnetic conversion characteristics (for example, SNR) can be obtained in the magnetic tape 22 having a high recording density (for example, the magnetic tape 22 configured to be capable of recording signals at the shortest recording wavelength of 44 nm or less). Meanwhile, when the average particle size of the magnetic powder is 8 nm or more, dispersibility of the magnetic powder is improved, and additionally excellent electromagnetic conversion characteristics (for example, SNR) can be obtained.

When the magnetic particles are the ε iron oxide particles, the average aspect ratio of the magnetic powder is favorably 1.0 or more and 3.0 or less, more favorably 1.0 or more and 2.5 or less, further more favorably 1.0 or more and 2.1 or less, particularly favorably 1.0 or more and 1.8 or less. When the average aspect ratio of the magnetic powder is within the range of 1.0 or more and 3.0 or less, the agglomeration of the magnetic powder can be suppressed. In addition, resistance applied to the magnetic powder when vertically orienting the magnetic powder in the process of forming the magnetic layer 43 can be suppressed. Accordingly, the vertical orientation of the magnetic powder can be improved.

When the magnetic powder contains the ε iron oxide particle powder, the average particle size and average aspect ratio of the magnetic powder are obtained as follows. First, the magnetic tape 22 as the measurement target is processed and sectioned by the FIB (Focused Ion Beam) method or the like. When using the FIB method, a carbon layer and a tungsten layer are formed as protective films as preprocessing for observing a TEM image of a cross section to be described later. The carbon layer is formed on the surface of the magnetic tape 22 on the magnetic layer 43 side and the surface thereof on the back layer 44 side by the vapor deposition method, and then the tungsten layer is further formed on the surface on the magnetic layer 43 side by the vapor deposition method or the sputtering method. The sectioning is performed along the length direction (longitudinal direction) of the magnetic tape 22. In other words, by the sectioning, a cross section parallel to both the longitudinal direction and the thickness direction of the magnetic tape 22 is formed.

Using the transmission electron microscope (H-9500 manufactured by Hitachi High-Tech Corporation), the cross section of the obtained sectioned sample is subjected to a cross-sectional observation at an acceleration voltage of 200 kV and a total magnification of 500,000 folds in such a manner that the entire magnetic layer 43 is included with respect to the thickness direction of the magnetic layer 43, to thus capture a TEM picture. Next, from the captured TEM picture, 50 particles whose particle shapes can be visibly confirmed are picked out, and a long axis length DL and short axis length DS of each particle are measured. Herein, the long axis length DL refers to a maximum distance (so-called maximum Feret's diameter) out of distances among two parallel lines drawn from various angles so as to come into contact with an outline of each of the particles. On the other hand, the short axis length DS refers to a maximum length out of lengths of a particle in directions orthogonal to the long axis (DL) of the particle. Subsequently, the measured long axis lengths DL of the 50 particles are simply averaged (arithmetic average) to obtain an average long axis length DLₐᵥₑ. The average long axis length DLₐᵥₑ obtained in this manner is set as the average particle size of the magnetic powder. Furthermore, the measured short axis lengths DS of the 50 particles are simply averaged (arithmetic average) to obtain an average short axis length DSₐᵥₑ. Then, an average aspect ratio (DLₐᵥₑ/DSₐᵥₑ) of the particles is obtained from the average long axis length DLₐᵥₑ and the average short axis length DSₐᵥₑ.

When the magnetic powder contains ε iron oxide particle powder, the average particle volume of the magnetic powder is favorably 5600 nm³ or less, more favorably 250 nm³ or more and 4200 nm³ or less, further more favorably 600 nm³ or more and 3000 nm³ or less, particularly favorably 600 nm³ or more and 2200 nm³ or less, most favorably 600 nm³ or more and 1500 nm³ or less. Since noises of the magnetic tape 22 are inversely proportional to a square root of the number of particles (that is, proportional to a square root of a particle volume) in general, additionally excellent electromagnetic conversion characteristics (for example, SNR) can be obtained by further reducing the particle volume. Accordingly, when the average particle volume of the magnetic powder is 5600 nm³ or less, additionally excellent electromagnetic conversion characteristics (for example, SNR) can be obtained similar to the case where the average particle size of the magnetic powder is 22 nm or less. Meanwhile, when the average particle volume of the magnetic powder is 250 nm³ or more, effects similar to those of the case where the average particle size of the magnetic powder is 8 nm or more can be obtained.

When the ε iron oxide particle has a spherical shape, the average particle volume of the magnetic powder is obtained as follows. First, the average long axis length DLₐᵥₑ is obtained similarly to the method of calculating the average particle size of the magnetic powder. Next, the average volume V of the magnetic powder is obtained by the following equation.

$$V = ( \prod / 6 ) \times {DL}_{ave}^{3}$$

When the ε iron oxide particle has a cubic shape, the average volume of the magnetic powder is obtained as follows. The magnetic tape 22 is processed and sectioned by the FIB (Focused Ion Beam) method or the like. When using the FIB method, a carbon film and a tungsten thin film are formed as protective films as preprocessing for observing a TEM image of a cross section to be described later. The carbon film is formed on the surface of the magnetic tape 22 on the magnetic layer 43 side and the surface thereof on the back layer 44 side by the vapor deposition method, and then the tungsten thin film is further formed on the surface on the magnetic layer 43 side by the vapor deposition method or the sputtering method. The sectioning is performed along the length direction (longitudinal direction) of the magnetic tape 22. In other words, by the sectioning, a cross section parallel to both the longitudinal direction and the thickness direction of the magnetic tape 22 is formed.

Using the transmission electron microscope (H-9500 manufactured by Hitachi High-Tech Corporation), the obtained sectioned sample is subjected to a cross-sectional observation at an acceleration voltage of 200 kV and a total magnification of 500,000 folds in such a manner that the entire magnetic layer 43 is included with respect to the thickness direction of the magnetic layer 43, to thus obtain a TEM picture. It is noted that the magnification and acceleration voltage may be adjusted as appropriate in accordance with the type of the device. Next, from the captured TEM picture, 50 particles whose particle shapes can be visibly confirmed are picked out, and a side length DC of each particle is measured. Subsequently, the measured side lengths DC of the 50 particles are simply averaged (arithmetic average) to obtain an average side length DCₐᵥₑ. Next, an average volume Vave (particle volume) of the magnetic powder is obtained by the following equation using the average side length DCₐᵥₑ.

$${V}_{ave} = {DC}_{ave}^{3}$$

### (Cobalt Ferrite Particles)

It is favorable for the cobalt ferrite particles to have a uniaxial crystal anisotropy. By the uniaxial crystal anisotropy of the cobalt ferrite particles, the magnetic powder can have a crystalline orientation preferentially in the thickness direction (vertical direction) of the magnetic tape 22. The cobalt ferrite particles have, for example, a cubic shape. In the present specification, the cubic shape includes a substantially cubic shape. Co-containing spinel ferrite may further include at least one type selected from Ni, Mn, Al, Cu, and Zn in addition to Co.

Co-containing spinel ferrite has an average composition expressed by the following formula, for example.

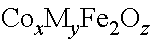

(provided that in the formula, M is, for example, at least one type of metal selected from Ni, Mn, Al, Cu, and Zn, x is a value within a range of 0.4≤x≤1.0, and y is a value within a range of 0≤y≤0.3; and provided that x and y satisfy a relationship of (x+y)≤1.0, z is a value within a range of 3≤z≤4, and a part of Fe may be substituted by other metal elements.)

When the magnetic powder contains cobalt ferrite particle powder, an average particle size of the magnetic powder is 22 nm or less. The average particle size (average maximum particle size) of the magnetic powder is favorably 20 nm or less, more favorably 8 nm or more and 20 nm or less, further more favorably 10 nm or more and 18 nm or less, particularly favorably 10 nm or more and 16 nm or less, most favorably 10 nm or more and 14 nm or less. When the average particle size of the magnetic powder is 22 nm or less, additionally excellent electromagnetic conversion characteristics (for example, SNR) can be obtained in the magnetic tape 22 having a high recording density. Meanwhile, when the average particle size of the magnetic powder is 8 nm or more, dispersibility of the magnetic powder is additionally improved, and additionally excellent electromagnetic conversion characteristics (for example, SNR) can be obtained. The method of calculating the average particle size of the magnetic powder is similar to the method of calculating the average particle size of the magnetic powder in the case where the magnetic powder contains ε iron oxide particle powder.

The average aspect ratio of the magnetic powder is favorably 1.0 or more and 3.0 or less, more favorably 1.0 or more and 2.5 or less, further more favorably 1.0 or more and 2.1 or less, particularly favorably 1.0 or more and 1.8 or less. When the average aspect ratio of the magnetic powder is within the range of 1.0 or more and 3.0 or less, the agglomeration of the magnetic powder can be suppressed. In addition, resistance applied to the magnetic powder when vertically orienting the magnetic powder in the process of forming the magnetic layer 43 can be suppressed. Accordingly, the vertical orientation of the magnetic powder can be improved. The method of calculating the average aspect ratio of the magnetic powder is similar to the method of calculating the average aspect ratio of the magnetic powder in the case where the magnetic powder contains ε iron oxide particle powder.

When the magnetic powder contains cobalt ferrite particle powder, the average particle volume of the magnetic powder is favorably 5600 nm³ or less, more favorably 250 nm³ or more and 4200 nm³ or less, further more favorably 600 nm³ or more and 3000 nm³ or less, particularly favorably 600 nm³ or more and 2200 nm³ or less, most favorably 600 nm³ or more and 1500 nm³ or less. When the average particle volume of the magnetic powder is 5600 nm³ or less, effects similar to those of the case where the average particle size of the magnetic powder is 25 nm or less can be obtained. Meanwhile, when the average particle volume of the magnetic powder is 500 nm³ or more, effects similar to those of the case where the average particle size of the magnetic powder is 8 nm or more can be obtained. The method of calculating the average particle volume of the magnetic powder is similar to the method of calculating the average particle volume in the case where the ε iron oxide particles have a cubic shape.

### (Binding Agent)

Examples of the binding agent include a thermoplastic resin, a thermoset resin, a reactive resin, and the like. Examples of the thermoplastic resin include vinyl chloride, vinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-acrylonitrile copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, cellulose derivatives (cellulose acetate butyrate, cellulose diacetate, cellulose triacetate, cellulose propionate, nitrocellulose), a styrene butadiene copolymer, a polyurethane resin, a polyester resin, an amino resin, synthetic rubber, and the like.

Examples of the thermoset resin include a phenol resin, an epoxy resin, a polyurethane curable resin, a urea resin, a melamine resin, an alkyd resin, a silicone resin, a polyamine resin, a urea formaldehyde resin, and the like.

For the purpose of improving dispersibility of the magnetic powder, polar functional groups including —SO₃M, —OSO₃M, —COOM, P═O(OM)₂ (provided that in the formulae, M represents a hydrogen atom or alkali metal such as lithium, potassium, and sodium), side chain type amine including terminal groups expressed by —NR1R2 and —NR1R2R3⁺X⁻, main chain type amine expressed by >NR1R2⁺X⁻ (provided that in the formulae, R1, R2, and R3 each represent a hydrogen atom or a hydrocarbon group, and X⁻ represents a halogen element ion of fluorine, chlorine, bromine, iodine, and the like, an inorganic ion, or an organic ion), and furthermore, —OH, —SH, —CN, an epoxy group, and the like may be introduced into all of the binding agents described above. An introduction amount of these polar functional groups into the binding agent is favorably 10⁻¹ to 10⁻⁸ mol/g, more favorably 10⁻² to 10⁻⁶ mol/g.

### (Lubricant)

The lubricant includes, for example, at least one type selected from fatty acid and fatty acid ester, or favorably both of fatty acid and fatty acid ester. The magnetic layer 43 containing the lubricant, in particular, the magnetic layer 43 containing both of fatty acid and fatty acid ester, contributes to an improvement of traveling stability of the magnetic tape 22. More particularly, by the magnetic layer 43 containing the lubricant and including pores, favorable traveling stability is achieved. The improvement of the traveling stability is considered to be because a kinetic friction coefficient of the surface of the magnetic tape 22 on the magnetic layer 43 side is adjusted to a value suited for traveling of the magnetic tape 22 by the lubricant.

Fatty acid may favorably be a compound indicated by the following general formula (1) or (2). For example, one of the compound indicated by the following general formula (1) or the compound indicated by the general formula (2), or both may be contained as fatty acid.

Furthermore, fatty acid ester may favorably be a compound indicated by the following general formula (3) or (4). For example, one of the compound indicated by the following general formula (3) or the compound indicated by the general formula (4), or both may be contained as fatty acid ester.

By the lubricant containing one or both of the compound indicated by the general formula (1) and the compound indicated by the general formula (2) and one or both of the compound indicated by the general formula (3) and the compound indicated by the general formula (4), an increase of the kinetic friction coefficient due to repetitive recording or reproduction of the magnetic tape 22 can be suppressed.

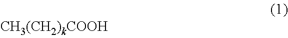

(provided that in the general formula (1), k is an integer selected from a range of 14 or more and 22 or less, more favorably a range of 14 or more and 18 or less.)

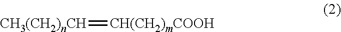

(provided that in the general formula (2), a sum of n and m is an integer selected from a range of 12 or more and 20 or less, more favorably a range of 14 or more and 18 or less.)

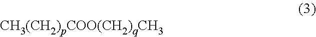

(provided that in the general formula (3), p is an integer selected from a range of 14 or more and 22 or less, more favorably a range of 14 or more and 18 or less, and q is an integer selected from a range of 2 or more and 5 or less, more favorably a range of 2 or more and 4 or less.)

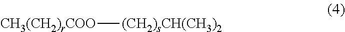

(provided that in the general formula (4), r is an integer selected from a range of 14 or more and 22 or less, and s is an integer selected from a range of 1 or more and 3 or less.)

### (Antistatic Agent)

Examples of the antistatic agent include carbon black, a natural surfactant, a non-ionic surfactant, a cationic surfactant, and the like.

### (Abrasive)

Examples of the abrasive include α-alumina having an α conversion rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing raw materials of magnetic iron oxide, a resultant obtained by treating a surface of those with aluminum and/or silica as necessary, and the like.

### (Curing Agent)

Examples of the curing agent include polyisocyanate and the like. Examples of polyisocyanate include aromatic polyisocyanate such as an adduct of tolylene diisocyanate (TDI) and an active hydrogen compound, aliphatic polyisocyanate such as an adduct of hexamethylene diisocyanate (HMDI) and an active hydrogen compound, and the like. A weight average molecular weight of these polyisocyanates is desirably within a range of 100 to 3000.

### (Rust Inhibitor)

Examples of the rust inhibitor include phenols, naphthols, quinones, a heterocyclic compound containing a nitrogen atom, a heterocyclic compound containing an oxygen atom, a heterocyclic compound containing a sulfur atom, and the like.

### (Non-Magnetic Reinforcement Particles)

Examples of the non-magnetic reinforcement particles include aluminum oxide (α, β or γ alumina), chromium oxide, silicon oxide, diamond, garnet, emery, boron nitride, titanium carbide, silicon carbide, titanium carbide, titanium oxide (rutile-type or anatase-type titanium oxide), and the like.

### (Underlayer)

The underlayer 42 is formed for mitigating asperities on the surface of the base material 41 and adjusting asperities on the surface of the magnetic layer 43. The underlayer 42 is a non-magnetic layer containing non-magnetic powder, a binding agent, and a lubricant. The underlayer 42 supplies the lubricant to the surface of the magnetic layer 43. The underlayer 42 may further contain at least one type of additive selected from an antistatic agent, a curing agent, a rust inhibitor, and the like as necessary.

An average thickness of the underlayer 42 is favorably 0.3 μm or more and 2.0 μm or less, more favorably 0.5 μm or more and 1.4 μm or less. It is noted that the average thickness of the underlayer 42 is obtained similarly to the average thickness of the magnetic layer 43. It is noted that a magnification of a TEM image is adjusted as appropriate according to the thickness of the underlayer 42. When the average thickness of the underlayer 42 is 2.0 μm or less, stretchability of the magnetic tape 22 by an external force becomes higher, and thus an adjustment of the width of the magnetic tape 22 by the tension adjustment becomes easier.

### (Non-Magnetic Powder)

The non-magnetic powder includes, for example, at least one type of inorganic particle powder or organic particle powder. Furthermore, the non-magnetic powder may be carbon powder such as carbon black. It is noted that one type of non-magnetic powder may be used alone, or two or more types of non-magnetic powder may be used in combination. The inorganic particles include, for example, metal, metal oxide, metal carbonate, metal sulfate, metal nitride, metal carbide, metal sulfide, and the like. Examples of the shape of the non-magnetic powder include various shapes such as an acicular shape, a spherical shape, a cubic shape, and a plate shape, but are not limited to these shapes.

### (Binding Agent, Lubricant)

The binding agent and the lubricant are similar to those of the magnetic layer 43 described above.

### (Additive)

The antistatic agent, the curing agent, and the rust inhibitor are similar to those of the magnetic layer 43 described above.

### (Back Layer)

The back layer 44 contains a binding agent and non-magnetic powder. The back layer 44 may further contain at least one type of additive selected from a lubricant, a curing agent, an antistatic agent, and the like as necessary. The binding agent and the non-magnetic powder are similar to those of the underlayer 42 described above.

An average particle size of the non-magnetic powder is favorably 10 nm or more and 150 nm or less, more favorably 15 nm or more and 110 nm or less. The average particle size of the non-magnetic powder is obtained similarly to the average particle size of the magnetic powder described above. The non-magnetic powder may include non-magnetic powder having two or more particle size distributions.

An upper limit value of an average thickness of the back layer 44 is favorably 0.6 μm or less. When the upper limit value of the average thickness of the back layer 44 is 0.6 μm or less, the thicknesses of the underlayer 42 and the base material 41 can be maintained thick even when the average thickness of the magnetic tape 22 is 5.6 μm or less, and thus the traveling stability of the magnetic tape 22 in the recording/reproducing device can be maintained. A lower limit value of the average thickness of the back layer 44 is not limited in particular and is, for example, 0.2 μm or more.

The average thickness t_{b} of the back layer 44 is obtained as follows. First, an average thickness tr of the magnetic tape 22 is measured. The measurement method for the average thickness t_{T} is as described in the following “average thickness of magnetic tape”. Subsequently, the back layer 44 of the sample is removed using a solvent such as MEK (methyl ethyl ketone) or dilute hydrochloric acid. Next, using the laser hologauge (LGH-110C) manufactured by Mitutoyo Corporation, the thickness of the sample is measured at five positions, and those measurement values are simply averaged (arithmetic average), to calculate an average value t_{B} [μm]. After that, the average thickness t_{b} [μm] of the back layer 44 is obtained by the following equation. It is noted that the measurement positions are randomly selected from the sample.

$${t}_{b} [ µm ] = {t}_{T} [ µm ] - {t}_{B} [ µm ]$$

The back layer 44 includes a surface provided with a large number of protrusion portions. The large number of protrusion portions are for forming a large number of hole portions on the surface of the magnetic layer 43 in a state where the magnetic tape 22 is wound in a roll. The large number of hole portions are constituted of a large number of non-magnetic particles protruding from the surface of the back layer 44, for example.

### (Average Thickness of Magnetic Tape)

An upper limit value of the average thickness (average total thickness) t_{T} of the magnetic tape 22 is 5.4 μm or less, favorably 5.2 μm or less, more favorably 5.1 μm or less, further more favorably 5.0 μm or less. When the average thickness t_{T} of the magnetic tape 22 is 5.4 μm or less, a recording capacity that can be recorded in one data cartridge can be made larger than a general magnetic tape. A lower limit value of the average thickness t_{T} of the magnetic tape 22 is not limited in particular and is, for example, 4.5 μm or more. It is noted that a total length of the magnetic tape 22 is 1000 m or more.

The average thickness t_{T} of the magnetic tape 22 is obtained as follows. First, the magnetic tape 22 having a width of ½ inch is prepared and cut out at a length of 250 mm, to produce a sample. Next, using the laser hologauge (LGH-110C) manufactured by Mitutoyo Corporation as the measurement device, a thickness of the sample is measured at five positions or more, and those measurement values are simply averaged (arithmetic average), to thus calculate the average thickness t_{T} [μm]. It is noted that the measurement positions are randomly selected from the sample.

### (Coercive Force Hc)

An upper limit value of a coercive force Hc2 of the magnetic layer 43 in the longitudinal direction of the magnetic tape 22 is favorably 2000 Oe or less, more favorably 1900 Oe or less, further more favorably 1800 Oe or less. When the coercive force Hc2 of the magnetic layer 43 in the longitudinal direction is 2000 Oe or less, sufficient electromagnetic conversion characteristics can be obtained even with a high recording density.

A lower limit value of the coercive force Hc2 of the magnetic layer 43 measured in the longitudinal direction of the magnetic tape 22 is favorably 1000 Oe or more. When the coercive force Hc2 of the magnetic layer 43 measured in the longitudinal direction is 1000 Oe or more, demagnetization due to a leakage magnetic flux from the recording head can be suppressed.

The coercive force Hc2 described above is obtained as follows. First, after three magnetic tapes 22 are superimposed on one another using a double-sided tape, the magnetic tapes 22 are punched with a punch having φ of 6.39 mm, to produce a measurement sample. At this time, marking is performed using arbitrary ink not having a magnetic property so that the longitudinal direction (traveling direction) of the magnetic tape 22 can be recognized. Then, using a vibrating sample magnetometer (Vibrating Sample Magnetometer: VSM), an M-H loop of the measurement sample (entire magnetic tape 22) corresponding to the longitudinal direction (traveling direction) of the magnetic tape 22 is measured. Next, acetone, ethanol, or the like is used to remove the coated films (the underlayer 42, the magnetic layer 43, the back layer 44, and the like) so that only the base material 41 remains. Then, after the obtained three base materials 41 are superimposed on one another using a double-sided tape, the base materials 41 are punched with the punch having φ of 6.39 mm, to obtain a background correction sample (hereinafter, will be simply referred to as “correction sample”). After that, an M-H loop of the correction sample (base material 41) corresponding to the vertical direction of the base material 41 (the vertical direction of the magnetic tape 22) is measured using the VSM.

In the measurements of the M-H loop of the measurement sample (entire magnetic tape 22) and the M-H loop of the correction sample (base material 41), a high-sensitivity vibrating sample magnetometer “VSM-P7-15” manufactured by Toei Industry Co., Ltd. is used. Measurement conditions are a measurement mode: full loop, a maximum magnetic field: 15 kOe, a magnetic field step: 40 bit, Time constant of Locking amp: 0.3 sec, Waiting time: 1 sec, an average number of MHs: 20.

After the M-H loop of the measurement sample (entire magnetic tape 22) and the M-H loop of the correction sample (base material 41) are obtained, the M-H loop of the correction sample (base material 41) is subtracted from the M-H loop of the measurement sample (entire magnetic tape 22) so that background correction is performed and an M-H loop that has been subjected to the background correction is obtained. A measurement/analysis program accompanying “VSM-P7-15” is used in this calculation of the background correction. The coercive force Hc2 is obtained from the obtained M-H loop that has been subjected to the background correction. It is noted that the measurement/analysis program accompanying “VSM-P7-15” is used in this calculation. It is assumed that the measurements of the M-H loops are both performed at 25° C. It is also assumed that “demagnetization field correction” when measuring the M-H loop in the longitudinal direction of the magnetic tape 22 is not performed.

### (Squareness Ratio)

A squareness ratio S1 of the magnetic layer 43 in the vertical direction (thickness direction) of the magnetic tape 22 is favorably 65% or more, more favorably 70% or more, further more favorably 75% or more, particularly favorably 80% or more, most favorably 85% or more. When the squareness ratio S1 is 65% or more, the vertical orientation of the magnetic powder becomes sufficiently high, and thus additionally excellent electromagnetic conversion characteristics (for example, SNR) can be obtained.

The squareness ratio S1 in the vertical direction is obtained as follows. First, after three magnetic tapes 22 are superimposed on one another using a double-sided tape, the magnetic tapes 22 are punched with a punch having φ of 6.39 mm, to produce a measurement sample. At this time, marking is performed using arbitrary ink not having a magnetic property so that the longitudinal direction (traveling direction) of the magnetic tape 22 can be recognized. Then, using the VSM, an M-H loop of the measurement sample (entire magnetic tape 22) corresponding to the longitudinal direction (traveling direction) of the magnetic tape 22 is measured. Next, acetone, ethanol, or the like is used to remove the coated films (the underlayer 42, the magnetic layer 43, the back layer 44, and the like) so that only the base material 41 remains. Then, after the obtained three base materials 41 are superimposed on one another using a double-sided tape, the base materials 41 are punched with the punch having φ of 6.39 mm, to obtain a background correction sample (hereinafter, will be simply referred to as “correction sample”). After that, an M-H loop of the correction sample (base material 41) corresponding to the vertical direction of the base material 41 (the vertical direction of the magnetic tape 22) is measured using the VSM.

In the measurements of the M-H loop of the measurement sample (entire magnetic tape 22) and the M-H loop of the correction sample (base material 41), the high-sensitivity vibrating sample magnetometer “VSM-P7-15” manufactured by Toei Industry Co., Ltd. is used. Measurement conditions are the measurement mode: full loop, the maximum magnetic field: 15 kOe, the magnetic field step: 40 bit, Time constant of Locking amp: 0.3 sec, Waiting time: 1 sec, the average number of MHs: 20.

After the M-H loop of the measurement sample (entire magnetic tape 22) and the M-H loop of the correction sample (base material 41) are obtained, the M-H loop of the correction sample (base material 41) is subtracted from the M-H loop of the measurement sample (entire magnetic tape 22) so that background correction is performed and an M-H loop that has been subjected to the background correction is obtained. The measurement/analysis program accompanying “VSM-P7-15” is used in this calculation of the background correction.

A saturation magnetization Ms (emu) and remanent magnetization Mr (emu) of the obtained M-H loop that has been subjected to the background correction are substituted into the following equation, to thus calculate the squareness ratio S1(%). It is noted that the measurements of the M-H loops are both performed at 25° C. Furthermore, it is assumed that the “demagnetization field correction” when measuring the M-H loop in the vertical direction of the magnetic tape 22 is not performed. It is noted that the measurement/analysis program accompanying “VSM-P7-15” is used in this calculation.

$$Squareness ratio S 1 ( \% ) = ( Mr / Ms ) \times 100 )$$

A squareness ratio S2 of the magnetic layer 43 in the longitudinal direction (traveling direction) of the magnetic tape 22 is favorably 35% or less, more favorably 30% or less, further more favorably 25% or less more, particularly favorably 20% or less, most favorably 15% or less. When the squareness ratio S2 is 35% or less, the vertical orientation of the magnetic powder becomes sufficiently high, and thus additionally excellent electromagnetic conversion characteristics (for example, SNR) can be obtained.

The squareness ratio S2 in the longitudinal direction is obtained similarly to the squareness ratio S1 except that the M-H loop is measured in the longitudinal direction (traveling direction) of the magnetic tape 22 and the base material 41.

### (Surface Roughness Rb of Back Surface)

A surface roughness Rb of the back surface (the surface roughness of the back layer 44) is favorably Rb≤6.0 [nm]. When the surface roughness Rb of the back surface is within the range described above, additionally excellent electromagnetic conversion characteristics can be obtained.

### [Tape Drive Device]

Next, the tape drive device will be described. FIG. 5 is a plan view showing a schematic configuration of a tape drive device 100 used for recording and/or reproduction of the tape cartridge 1.

The tape drive device 100 includes: an attachment portion 101; a loading mechanism (not shown) for drawing out the magnetic tape 22 from the tape cartridge 1 attached to the attachment portion 101; a take-up reel 102 which reels in the magnetic tape 22 drawn out by the loading mechanism; a plurality of guide rollers 103a, 103b, 103c, and 103d that guide traveling of the magnetic tape 22 as well as form a tape path from the tape cartridge 1 to the take-up reel 102; and a magnetic head 104 as a head portion arranged opposed to a magnetic surface of the magnetic tape 22. While causing the take-up reel 102 to rotate in a tape winding direction or a tape rewinding direction, the tape drive device 100 records information onto the magnetic tape 22 by the magnetic head 104 or reproduces information recorded onto the magnetic tape 22.

Herein, as the tape drive device, for example, there is known, in addition to a full-height-type drive device applied to a large-scale library, a half-height-type drive device that is configured to have half the height of the full height type. The only difference between the full-height-type tape drive device and the half-height-type tape drive device is their heights, and there is no significant difference in information recording/reproducing performance with respect to the tape cartridge. Thus, under the current circumstances, the devices are used distinguishably according to usage environments of users.

However, depending on the configuration of the tape cartridge, anomalies in recording/reproducing operations that are unproblematic during use of the full-height-type tape drive device may be caused during use of the half-height-type tape drive device. This is predicted to be because effects of shape accuracy of mechanism components configuring the tape drive device, processing accuracy or rigidity of the magnetic tape, and furthermore, differences in terms of configurations or physical properties of a tape reel structure and the like on the recording/reproducing operations appear prominently in the half-height-type tape drive device.

Specifically, there is a fear that during use of the half-height-type tape drive device, the relative position of the tape with respect to the magnetic head will vary due to lowering of linearity that is unavoidable in a manufacturing process of the magnetic tape, lowering of shape accuracy of the take-up reel in the tape drive device, and the like, to inhibit normal information recording or reproducing operations by the magnetic head.

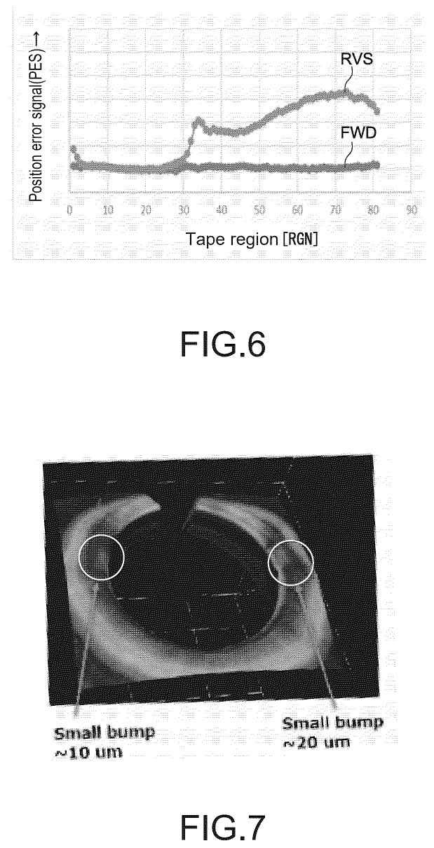

For example, FIG. 6 is an experimental result showing a relationship between a tape length and a magnitude of a position error signal (PES: Position Error Signal) of a data track when information is recorded onto the magnetic tape using the half-height-type tape drive device. In the figure, FWD indicates the winding direction of the magnetic tape (the direction in which the magnetic tape is reeled in by the take-up reel of the tape drive device from the tape reel of the tape cartridge), and RVS indicates the rewinding direction of the magnetic tape (the direction in which the magnetic tape is reeled in by the tape reel of the tape cartridge from the take-up reel of the tape drive device). The tape drive device acquires data while sectioning the total length of the magnetic tape into 80 regions (Region: RGN), and in the figure, the abscissa axis represents a number of the region (RGN).

It is noted that the average total thickness of the magnetic tape used was 5.2 μm, the base material was formed of PET (polyethylene terephthalate), and a thickness thereof was 4.0 μm. It is noted that a loop stiffness of this magnetic tape in an MD direction (tape longitudinal direction) was 1.5 mg/μm, and a loop stiffness thereof in a TD direction (tape width direction) was 1.6 mg/μm. Hereinafter, this magnetic tape will also be referred to as magnetic tape according to the comparative example.

As shown in FIG. 6, in the half-height-type tape drive device, it was confirmed that while the PES is substantially uniform across the total tape length in the winding direction of the magnetic tape (FWD), the PES largely varies across a section of 50 RGNs (80 RGNs-30 RGNs) from a start of the rewinding operation in the rewinding direction (RVS). In addition, a measurement of a probability of an occurrence of a data writing failure (hereinafter, will also be referred to as capacity loss) with respect to a maximum recording capacity of this magnetic tape resulted in the value of 26.6%.

In this regard, when observing the magnetic tape 22 wound on the take-up reel 102 of the tape drive device, a deformation due to abnormal winding of the magnetic tape 22 was confirmed on the hub of the take-up reel 102 during initial winding. Furthermore, upon measuring a surface shape of the flange of the take-up reel 102, it was confirmed that a partially-raised area exists at two positions on an outer circumferential surface of the hub (areas respectively indicated by circles in the figure) as shown in FIG. 7, and that small bumps each having a height of about 10 μm to 20 μm exist on a lower flange side of the hub outer circumferential surface of those areas. The hub of the take-up reel 102 is a molded body that is formed of a synthetic resin material and formed integrally with the lower flange, and it is considered that these bumps have been generated unavoidably due to a molding failure such as a sink. Furthermore, it is considered that as a result of the magnetic tape 22 being wound in multiple layers over these bumps, the magnetic tape 22 is deformed, and a position error during traveling as described above has become large because of this, to thus worsen the capacity loss.

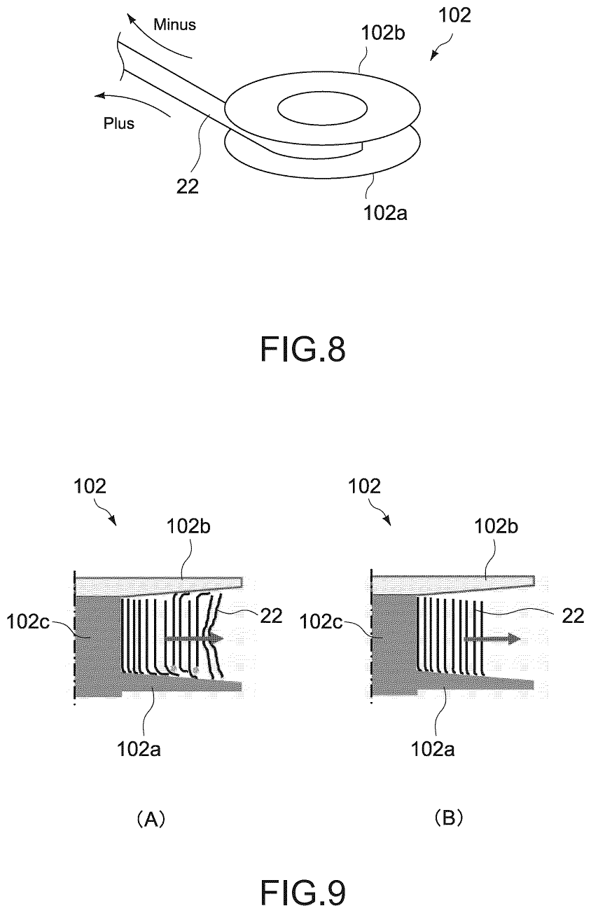

Meanwhile, the magnetic tape 22 is not always linear and may be slightly curved due to reasons associated with a process of cutting the magnetic tape 22 into a product width, for example. As schematically shown in FIG. 8, the magnetic tape 22 has two curvature directions of minus and plus. Herein, the minus curvature direction refers to the magnetic tape 22 curving in a direction in which the magnetic tape 22 becomes convex toward a lower flange 102a side of the take-up reel 102, and the plus curvature direction refers to the magnetic tape 22 curving in a direction in which the magnetic tape 22 becomes convex toward an upper flange 102b side of the take-up reel 102. In both the minus and plus curvature directions, the magnetic tape unwound from the tape reel 5 of the tape cartridge 1 is reeled in by the take-up reel 102 of the tape drive device 100 while repeating up and down motions.

At this time, when there is an abnormal winding of the magnetic tape 22 at a lower portion of the hub of the take-up reel 102 as described above, and when the curvature direction of the magnetic tape 22 is minus, the magnetic tape 22 is apt to be wound toward an upper portion of the hub 102c (the upper flange 102b side) as schematically shown in FIG. 9(A), and as a result, the magnetic tape 22 is apt to come into contact with the inner surface of the upper flange 102b so that a tape edge is deformed. Furthermore, as a reaction to the contact with the inner surface of the upper flange 102b, the magnetic tape 22 is wound around the reel hub 102c toward the lower flange 102a side, and thus the tape edge on the opposite side is apt to be deformed due to the contact with the inner surface of the lower flange 102a.

In contrast, when the curvature direction of the magnetic tape 22 is plus, the magnetic tape 22 is apt to be wound around the reel hub 102c while the tape edge is in contact with the lower flange 102a side as schematically shown in FIG. 9(B), and is, in whole, stably wound on the area at the lower portion (lower flange 102a side) of the hub 102c. In this manner, when the curvature direction of the magnetic tape 22 is plus, the deformation of the tape edge is suppressed as compared to the case where the curvature direction is minus, so it is possible to reduce the capacity loss, but it is favorable to suppress the tape damage due to the contact with the lower flange 102a as much as possible.

In this regard, in the tape cartridge 1 according to the present embodiment, the magnetic tape 22 and the tape reel 5 are configured as follows for securing stable recording/reproducing characteristics irrespective of the type of the tape drive device.

### [Details of Magnetic Tape]

In the present embodiment, the magnetic tape 22 includes the base material 41 and the magnetic layer 43 provided on one of the main surfaces of the base material 41, the base material 41 is formed of polyethylene naphthalate (PEN), a total thickness of the magnetic tape 22 is 4.9 μm or more and 5.4 μm or less, and a loop stiffness of the magnetic tape 22 in the width direction is 1.1 mg/μm or more and 1.4 mg/μm or less. The tape width of the magnetic tape 22 is 12.65 mm.

PEN has a higher tension strength and Young's modulus than PET. Accordingly, the base material 41 formed of PEN has a property that it has a higher rigidity and is less likely to be deformed than a base material formed of PET, which is formed to have the same thickness as the base material 41 formed of PEN. The base material 41 formed of PEN may be a uniaxially stretched film or a biaxially stretched film.

According to the magnetic tape 22 including the base material 41 formed of PEN, also when small bumps as described above are present on the hub outer circumferential surface of the take-up reel 102 of the tape drive device 100, a deformation amount of the magnetic tape 22 becomes smaller than that of the magnetic tape including the base material formed of PET, and thus it is possible to suppress an occurrence of the abnormal winding on the take-up reel 102.

The loop stiffness of the base material 41 formed of PEN in the TD direction is favorably 1.1 mg/μm or more and 1.4 mg/μm or less. When the loop stiffness exceeds 1.4 mg/μm, the rigidity of the base material 41 becomes too high to inhibit the deformation of the tape edge when it comes into contact with the upper flange or the lower flange, and thus the tape rather becomes more susceptible to damage. When the loop stiffness is smaller than 1.1 mg/μm, sufficient rigidity cannot be secured, and it becomes difficult to obtain desired effects.

For stably keeping the loop stiffness in the width direction of the magnetic tape 22 within the range described above, it is favorable for the total thickness (average total thickness) of the magnetic tape 22 to be 4.9 μm or more and 5.4 μm or less. Herein, the Young's modulus in the width direction of the magnetic tape 22 is set to 7.8 GPa/mm². It is noted that the loop stiffness in the width direction of the magnetic tape 22 can be measured in accordance with ECMA-319 Standard 9.16 Flexural rigidity (JIS X 6175 (2006) page 38).

Furthermore, a shrinkage rate of the magnetic tape 22 in the longitudinal direction when stored at 70° C. for 48 hours is favorably 0.1% or less. Thus, it becomes difficult for the width of the magnetic tape 22 to vary due to the temperature and the like (for example, even under a long-term accelerated deterioration environment such as one month at 45° C.). Accordingly, it is possible to prevent off-tracks from occurring, and accurately record data onto the magnetic tape 22 or accurately reproduce data recorded onto the magnetic tape 22. The shrinkage rate in the longitudinal direction may be 0.09% or less, 0.08% or less, 0.07% or less, 0.06% or less, 0.05% or less, or the like.

Furthermore, TDS (Transverse Dimensional Stability) of the magnetic tape 22 is an index for evaluating dimensional stability of the magnetic tape 22 in the width direction, and is expressed by an absolute value of a dimensional change rate of the magnetic tape 22 in the width direction. Causes of the dimensional change in the width direction include (1) a change in distortion of the tape due to a change over time, (2) a change due to a temperature and a humidity, and (3) a change due to a drive tension during traveling, and the smaller the TDS value is, the higher the dimensional stability in the width direction becomes. Particularly in LTO9, for controlling the drive tension, a reference width of the magnetic tape 22 is determined, and the tension of the magnetic tape 22 is adjusted so that the width of the magnetic tape 22 becomes a reference value during data recording/reproduction.

It is favorable for the magnetic tape 22 configured as described above to have the plus curvature direction. Thus, the magnetic tape 22 is stably wound on the area at the lower portion (lower flange 102a side) of the hub 102c of the take-up reel 102 as shown in FIG. 9(B). Thus, since the deformation of the tape edge is suppressed as compared to the case where the curvature direction is minus, the capacity loss can be reduced. In addition, since the base material 41 is formed of PEN as described above, it is less susceptible to the effect of the small bumps that are present on the outer circumferential surface of the hub 102c, and thus it is possible to suppress the deformation of the magnetic tape 22 and the occurrence of the abnormal winding on the take-up reel 102 due to the effect of the small bumps.

It is noted that a magnitude of the curvature of the magnetic tape 22 is set such that a deviation of the magnetic tape 22 from a chord having a length of 1 m is 3.8 mm or less. When the deviation exceeds 3.8 mm, the curvature becomes too strong, and it rather becomes impossible to suppress the deformation of the tape edge.

### [Details of Tape Reel]

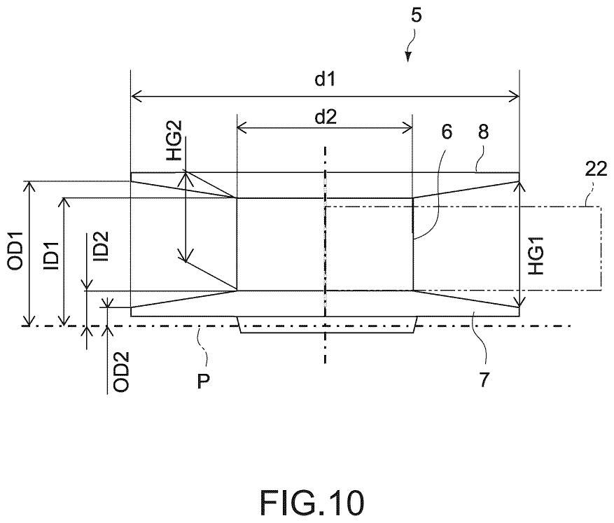

FIG. 10 is a schematic side view of the tape reel 5 according to the present embodiment.

As described above, the tape reel 5 includes the reel hub 6, the lower flange 7 as a first flange, and the upper flange 8 as a second flange. In the present embodiment, the lower flange 7 is formed integrally with the lower end portion (first end portion) of the reel hub 6, and the upper flange 8 is bonded to the upper end portion (second end portion) of the reel hub 6 by ultrasonic bonding or the like. The reel hub 6 has a generally cylindrical shape, and a height thereof in the axial direction is about 13 mm, which is slightly larger than the width of the magnetic tape 22 (12.65 mm). An inner diameter of the reel hub 6 is about 40 mm (39.6 mm), and a thickness thereof which is a thickness dimension in a radial direction is about 2 mm.

The reel hub 6 and the lower flange 7 are molded integrally using a synthetic resin material such as PC (polycarbonate) and ABS (acrylonitrile butadiene styrene). Similarly, the upper flange 8 is also molded using a synthetic resin material such as PC and ABS. The molding material for the reel hub 6 and the lower flange 7 may be a composite material in which an inorganic filler such as a glass filler is added to the synthetic resin material described above for the purpose of improving the strength. A weight ratio of the glass filler is not limited in particular and is, for example, about 10% or more and 30% or less by the weight ratio of the synthetic resin material to be the base. In the present embodiment, a composite material in which a polycarbonate resin contains the glass filler at a weight ratio of 10% or more and 20% or less is used as the molding material for the reel hub 6.

In FIG. 10, dimensions of the respective portions are as follows.
d1 (outer diameters of lower flange 7 and upper flange 8): 96.80 mm
d2 (diameter of hub 6): 44.00 mm±0.10 mm
OD1 (distance from inner side of upper flange 8 at outer diameter d1 to reference plane P): 14.905 mm±0.075 mm
ID1 (distance from inner side of upper flange 8 at diameter d2 to reference plane P): 14.82 mm±0.04 mm
OD2 (distance from inner side of lower flange 7 at outer diameter d1 to reference plane P): 1.78 mm±0.12 mm.
ID2 (distance from inner side of lower flange 7 at diameter d2 to reference plane P): 1.92 mm±0.10 mm
HG1 (distance from inner side of upper flange 8 to inner side of lower flange 7 at outer diameter d1)=OD1−OD2: 13.125 mm±0.195 mm
HG2 (distance from inner side of upper flange 8 to inner side of lower flange 7 at diameter d2)=ID1−ID2: 12.9 mm±0.14 mm

It is noted that the relationship of HG1>HG2 is satisfied.

Herein, the reference plane P is a plane defined by a pitch line of hub teeth (chucking gear 9 in FIG. 1(B)) at a diameter of 37.50 m, and is a position that is ½ the dimension from a virtual tip end to bottom of the teeth (ECMA-319 Standard 8.6.6 Reel hub (JIS X 6175 (2006) page 14)).

Table 1 shows dimensional differences of the respective portions between the tape reel used in the experimental example shown in FIG. 6 (a tape reel on which the magnetic tape according to the comparative example is wound; hereinafter, will also be referred to as tape reel according to the comparative example) and the tape reel 5 according to the present embodiment.

TABLE 1

| | Comparative Example | Embodiment |
|---|---|---|
| OD1 [mm] | 15.02 ± 0.12 | 14.905 ± 0.0075 |
| ID1 [mm] | 14.88 ± 0.10 | 14.82 ± 0.04 |

| | |
|---|---|
| OD2 [mm] | 1.78 ± 0.12 |
| ID2 [mm] | 1.92 ± 0.10 |

| | | |
|---|---|---|
| HG1 [mm] | 13.24 ± 0.24 | 13.125 ± 0.195 |
| HG2 [mm] | 12.96 ± 0.20 | 12.9 ± 0.14 |

As shown in FIG. 10, the inner surface of the upper flange 8 and the inner surface of the lower flange 7 of the tape reel 5 are formed to be tapered surfaces that widen toward the outer circumferential side of the reel, thus making it less likely for an edge portion of the magnetic tape 22 to come into contact with the flanges during traveling.

Meanwhile, in the tape reel 5 according to the present embodiment, the distance OD1 and the distance ID1 are set to be smaller than those of the tape reel according to the comparative example. Therefore, the distances HG1 and HG2 between both flanges respectively at the flange outer diameter d1 and the diameter d2 of the hub 6 are smaller (flange interval is narrower) than those of the tape reel according to the comparative example.

In other words, a minimum value of the distance between the lower flange 7 and the upper flange 8 along the axial direction of the hub 6 (corresponding to HG2) is 12.96 mm±0.20 mm in the comparative example, whereas the minimum value is 12.9 mm±0.14 mm in the present embodiment, and a maximum value of the distance (corresponding to HG1) is 13.24 mm±0.24 mm in the comparative example, whereas the maximum value is 13.125 mm±0.195 mm in the present embodiment.

It is noted that when expressed by a relative ratio with respect to the tape width of the magnetic tape 22 (12.65 mm), HG1 is 1.03 times or more and 1.07 times or less of the tape width and HG2 is 1.01 times or more and 1.04 times or less of the tape width in the comparative example, whereas HG1 is 1.02 times or more and 1.05 times or less of the tape width and HG2 is 1.01 times or more and 1.03 times or less of the tape width in the present embodiment.

Furthermore, a tapered amount of the upper flange (a difference in height between inner and outer circumferential edge portions of the upper flange) in the tape reel according to the comparative example is 0.1 mm to 0.14 mm, whereas the tapered amount of the upper flange in the present embodiment is about 0.05 mm.

Therefore, in the present embodiment, an operation to restrict a traveling position of the magnetic tape 22 unwound from the tape reel 5 is stronger than that of the tape reel according to the comparative example, and thus the up and down motions of the magnetic tape 22 during traveling are small. Accordingly, according to the present embodiment, since the magnetic tape 22 is reeled in by the take-up reel 102 of the tape drive device 100 at a stable height position, a deformation amount of the tape edge due to the contact with the upper and lower flanges of the take-up reel 102 can be reduced.

Particularly in the present embodiment, since the base material of the magnetic tape 22 is formed of PEN, the rigidity is higher than that of the magnetic tape according to the comparative example which includes the base material formed of PET. Therefore, the deformation amount of the tape edge due to the contact with the upper and lower flanges of the take-up reel 102 can be further reduced. In addition, since, also in a case where small bumps are present on the hub outer circumferential surface of the take-up reel 102 as described above, the deformation of the magnetic tape 22 due to the small bumps can be suppressed, the occurrence of the abnormal winding of the magnetic tape 22 on the take-up reel 102 can be suppressed.

### Experimental Example

The inventors evaluated the capacity loss of the magnetic tape by recording and reproducing predetermined data across the entire length of the magnetic tape for the tape cartridge according to the comparative example and the tape cartridge 1 according to the present embodiment. The tape drive device used in the experiment was a half-height-type tape drive device (model number: TS2290) manufactured by IBM Corporation.

Herein, a case where a data write failure area is equal to or smaller than a predetermined capacity (17.4 TB or less (when uncompressed) in the present example) with respect to a total recording capacity of the magnetic tape 22 per tape cartridge (45 TB in LTO9 (18 TB when uncompressed)) was determined as a capacity loss failure, and the number thereof was counted. The method of determining presence or absence of the capacity loss failure involves: repeating only full volume write (Full Volume Write) five times for the total recording capacity of the magnetic tape 22 (45 TB in LTO9 (18 TB when uncompressed)); and determining as no capacity loss when an area where data has been written normally is 17.4 TB (when uncompressed) or more for all of the five times, and determining as a capacity loss when the area falls below 17.4 TB (when uncompressed) even once.

As a result of the experiment, the number of rolls with the capacity loss failure was 4 rolls out of 22 rolls in the tape cartridge according to the comparative example, whereas the number of rolls with the capacity loss failure was 0 out of 16 rolls in the tape cartridge according to the present embodiment.

As described above, according to the present embodiment, by forming the base material 41 of the magnetic tape 22 of PEN, the rigidity of the magnetic tape 22 can be increased, to thereby improve resistance of the tape edge to deformation that is caused by the contact with the flanges of the take-up reel of the tape drive device or by small bumps present on the hub outer circumferential surface. In addition, by limiting the distance between the flanges 7 and 8 of the tape reel 5, the traveling position of the magnetic tape 22 unwound from the tape reel 5 can be restricted, to thus suppress the abnormal winding on the take-up reel. As a result, PES characteristics during recording/reproduction of the magnetic tape 22 are improved, and the occurrence of a capacity loss in the magnetic tape 22 can be suppressed.

### Modified Example

In the embodiment described above, the magnetic tape and the tape reel for the tape cartridge conforming to the LTO standard have been described as the examples, but the present technology is also applicable to a magnetic tape and a tape reel for a tape cartridge conforming to standards other than LTO.

It is noted that the present technology can also take the following configurations.
(1) A magnetic tape, including:
   a base material; and
   a magnetic layer provided on one of main surfaces of the base material, in which
   the base material is formed of polyethylene naphthalate (PEN),
   a total thickness of the magnetic tape is 4.9 μm or more and 5.4 μm or less, and
   a loop stiffness of the magnetic tape in a width direction thereof is 1.1 mg/μm or more and 1.4 mg/μm or less.
(2) The magnetic tape according to (1) above, further including:
   a non-magnetic layer provided between the base material and the magnetic layer; and
   a back layer provided on another one of the main surfaces of the base material.
(3) The magnetic tape according to (1) or (2) above, in which
   a thickness of the base material is 4.2 μm or less.
(4) The magnetic tape according any one of (1) to (3) above, in which
   a thickness of the base material is 4.1 μm or less.
(5) The magnetic tape according to any one of (1) to (3) above, in which
   a thickness of the base material is 4.0 μm or less.
(6) The magnetic tape according to any one of (1) to (5) above, in which
   the magnetic layer contains magnetic particles of hexagonal ferrite, ε iron oxide, or cobalt-containing ferrite.
(7) The magnetic tape according to any one of (1) to (6) above, in which
   a squareness ratio of the magnetic layer in a longitudinal direction of the magnetic tape is 35% or less.
(8) The magnetic tape according to any one of (1) to (7) above, in which
   a coercive force of the magnetic layer is 2000 Oe or less.
(9) The magnetic tape according to any one of (1) to (8) above, in which
   a shrinkage rate of the magnetic tape in a longitudinal direction thereof when stored at 70° C. for 48 hours is 0.1% or less.
(10) A tape cartridge, including:
   a tape reel including a first flange, a second flange, and a cylindrical reel hub including a first end portion formed integrally with the first flange and a second end portion to which the second flange is bonded; and
   a magnetic tape which includes a base material and a magnetic layer provided on one of main surfaces of the base material and is wound on an outer circumferential surface of the reel hub, wherein
   the base material is formed of polyethylene naphthalate (PEN),
   a total thickness of the magnetic tape is 4.9 μm or more and 5.4 μm or less, and
   a loop stiffness of the magnetic tape in a width direction thereof is 1.1 mg/μm or more and 1.4 mg/μm or less.
(11) The tape cartridge according to (10) above, in which
   the magnetic tape is curved in a shape that becomes convex toward a side of the second flange, and a deviation of the magnetic tape from a chord having a length of 1 m is 3.8 mm or less.
(12) The tape cartridge according to (10) or (11) above, in which
   an inner surface of the first flange and an inner surface of the second flange are each formed as a tapered surface that widens toward an outer circumferential side of the tape reel.
(13) The tape cartridge according to (12) above, in which
   a minimum value of a distance between the first flange and the second flange along an axial direction of the hub is 12.9 mm±0.14 mm.
(14) The tape cartridge according to (12) or (13) above, in which
   a maximum value of a distance between the first flange and the second flange along an axial direction of the hub is 13.125 mm±0.195 mm.

### REFERENCE SIGNS LIST

1 tape cartridge
5 tape reel
6 reel hub
7 lower flange
8 upper flange
22 magnetic tape
41 base material
42 underlayer
43 magnetic layer
44 back layer
100 tape drive device
102 take-up reel

1. A magnetic tape, comprising:
a base material; and
a magnetic layer provided on one of main surfaces of the base material, wherein
the base material is formed of polyethylene naphthalate (PEN),
a total thickness of the magnetic tape is 4.9 μm or more and 5.4 μm or less, and
a loop stiffness of the magnetic tape in a width direction thereof is 1.1 mg/μm or more and 1.4 mg/μm or less.

2. The magnetic tape according to claim 1, further comprising:
a non-magnetic layer provided between the base material and the magnetic layer; and
a back layer provided on another one of the main surfaces of the base material.

3. The magnetic tape according to claim 1, wherein
a thickness of the base material is 4.2 μm or less.

4. The magnetic tape according to claim 1, wherein
a thickness of the base material is 4.1 μm or less.

5. The magnetic tape according to claim 1, wherein
a thickness of the base material is 4.0 μm or less.

6. The magnetic tape according to claim 1, wherein
the magnetic layer contains magnetic particles of hexagonal ferrite, ε iron oxide, or cobalt-containing ferrite.

7. The magnetic tape according to claim 1, wherein
a squareness ratio of the magnetic layer in a longitudinal direction of the magnetic tape is 35% or less.

8. The magnetic tape according to claim 1, wherein
a coercive force of the magnetic layer is 2000 Oe or less.

9. The magnetic tape according to claim 1, wherein
a shrinkage rate of the magnetic tape in a longitudinal direction thereof when stored at 70° C. for 48 hours is 0.1% or less.

10. A tape cartridge, comprising:
a tape reel including a first flange, a second flange, and a cylindrical reel hub including a first end portion formed integrally with the first flange and a second end portion to which the second flange is bonded; and
a magnetic tape which includes a base material and a magnetic layer provided on one of main surfaces of the base material and is wound on an outer circumferential surface of the reel hub, wherein
the base material is formed of polyethylene naphthalate (PEN),
a total thickness of the magnetic tape is 4.9 μm or more and 5.4 μm or less, and
a loop stiffness of the magnetic tape in a width direction thereof is 1.1 mg/μm or more and 1.4 mg/μm or less.

11. The tape cartridge according to claim 10, wherein
the magnetic tape is curved in a shape that becomes convex toward a side of the second flange, and a deviation of the magnetic tape from a chord having a length of 1 m is 3.8 mm or less.

12. The tape cartridge according to claim 10, wherein
an inner surface of the first flange and an inner surface of the second flange are each formed as a tapered surface that widens toward an outer circumferential side of the tape reel.

13. The tape cartridge according to claim 12, wherein
a minimum value of a distance between the first flange and the second flange along an axial direction of the hub is 12.9 mm±0.14 mm.

14. The tape cartridge according to claim 12, wherein
a maximum value of a distance between the first flange and the second flange along an axial direction of the hub is 13.125 mm±0.195 mm.
